(19) United States
(12) Patent Application Publication
(10) Pub. No.: US 2014/0255583 A1
(43) Pub. Date: Sep. 11, 2014

(54) PROTEIN SUSPENSION AS A BEVERAGE OPACIFIER SYSTEM

(71) Applicant: SUNNY DELIGHT BEVERAGES COMPANY, CINCINNATI, OH (US)

(72) Inventors: ROBERT SARAMA, LOVELAND, OH (US); GREGORY ARCUINO, CINCINNATI, OH (US)

(73) Assignee: SUNNY DELIGHT BEVERAGES COMPANY, CINCINNATI, OH (US)

(21) Appl. No.: 14/196,158

(22) Filed: Mar. 4, 2014

Related U.S. Application Data
(60) Provisional application No. 61/773,433, filed on Mar. 6, 2013.

(51) Int. Cl. A23L 2/62

(52) U.S. Cl. CPC A23L 2/62
USPC 426/580; 426/590

(57) ABSTRACT

The present invention is a composition which provides product opacity (“cloud”) to beverages without requiring the use of added oil. The beverage comprises a beverage matrix, a protein having a tertiary or quaternary structure (such as WPC 80) having an average particle size of from about 0.3 to about 10 μm and a hydrocolloid gum (such as gellan gum) which imparts thixotropic properties to the beverage matrix. The method for importing cloud to a beverage composition, using this composition, is also described.

### BACKGROUND

This application is related to and claims priority from U.S. Provisional Application No. 61/773,433, filed March 6, 2013, incorporated herein by reference.

Beverage products frequently use an oil-in-water (o/w) emulsion to provide product opacity (also known as “cloud”). Cloud is added to such beverages to enhance their visual appeal and sometimes to enhance mouthfeel. Beverage cloud emulsions produce opacity by providing a physical barrier, in the form of microscopic droplets, that limit light penetration and cause light to scatter. These microscopic oil-in-water droplets are homogeneously dispersed throughout the beverage and tend to be stable if the droplet size and density are optimized. Such cloud emulsions are frequently made up of canola oil, modified food starch, preservative and water.

Consumers sometimes look at the inclusion of unnecessary fat (such as canola oil) in a food or beverage product as a negative. Therefore, it would be desirable to be able to formulate a cloud (opacifying) agent which does not impart fat (oil) to the beverage.

It has been found that certain types of powdered whey protein can deliver the opacity equivalent of the current o/w emulsions. For example, the whey protein can be dispersed in a low pH (3.3) citric acid buffered system. However, within a few days these whey dispersions begin to coagulate and settle to the bottom. The rate of destabilization appears to correlate with the concentration of whey protein used (higher concentrations provide greater destabilization).

### SUMMARY

It has now been found that the protein suspension can be maintained if formulated into a matrix containing a suspending agent in the form of a hydrocolloid gum, for example, a linear polysaccharide comprised of a tetrasaccharide repeat of D-glucose, D-glucuronic acid, D-glucose and L-rhamnose. This matrix confers stability to the whey protein dispersion so that a stable, homogenous cloud is achieved. This oil-free, stable, homogeneous cloud can be incorporated into a beverage using whey protein as the stable opacifying agent with no negative impact on the beverage's rheology, drinkability, flavor or palatability.

Specifically, the present invention relates to an oil-free, stable opacified beverage comprising a beverage matrix which includes from about 0.1% to about 10% (by weight) of a protein having a tertiary or quaternary structure having an average particle size of from about 0.3 to about 10 μm, and from about 0.025% to about 0.5% (by weight) of a hydrocolloid gum which imparts thixotropic properties to the beverage matrix.

The method of providing cloud to a beverage using this composition is also claimed.

All ratios and ranges given herein are “by weight” unless otherwise specified.

### DETAILED DESCRIPTION

The invention herein relates to a method to provide an oil-free, stable, homogeneous cloud in a beverage, utilizing a whey protein product as an opacifying agent and a polysaccharide gum as the suspending agent.

As used herein, “oil-free” means that no oil is added to the product as a separate component (i.e., the only oil present is that which is present as an impurity in other components). Generally, this means that oil is not present at greater than 0.1% of the composition.

To achieve the desired qualities, the beverage formula weight percentage of protein can range from about 0.1% to about 10% (by weight) and the polysaccharide gum can range from about 0.025% to about 0.5% (by weight) of the beverage composition.

Whey proteins which have a tertiary or quaternary structure as monomers or as aggregates that are large enough to provide opacity when dispersed in solution can be used. The average particle size of such proteins in solution is generally from about 0.3 μm to about 10 μm, and may be up to about 100 μm. The particle size distribution of such proteins in solution can be measured using laser diffraction or dynamic light scattering techniques. An example is the Horiba LA-950 Laser Particle Size Analyzer.

Whey protein is commercially available. An example of a whey protein useful in the present invention is an extracted whey protein concentrate 80% (WPC80). WPC80 comprises from about 60% to about 80% protein, and no more than about 10% lactose, about 10% milk fat, and about 2% ash. The protein fraction is rich in β-lactoglobulin, α-lactoglobulin, and proteose-peptone, with minor contributions of serum albumin and immunoglobulins. The WPC80 powder particle size distribution is from about 50 μm to about 100 μm. The particle size distribution in this powder can be measured by any conventional method, such as by a sieving technique using woven wire sieves (screens). The powder has a light beige color with no caramelized or scorched flavors. Other endogenous or modified proteins of animal or plant origin can be used. Examples of such proteins include other milk proteins such as caseins; egg proteins such as vitellin, ovalbumin, and phosvitin; plant proteins from cultivated varieties of legumes, cereals, root crops, tree nuts and other nut or seed cultivars, and marine plants. The extracted proteins from these sources may be in the form of flours, protein concentrates or protein isolates. Proteins from these sources may be enzymatically treated to modify their properties.

The extracted WPC80, which may be used in the present invention, can be treated with a wash step to remove milk fats. This is done by combining the protein with acetone and agitating at ambient temperature for about 30 to 60 minutes.

The mixture is then centrifuged to remove the solvent and extracted materials and a pellet containing the whey protein is recovered and dried at ambient temperature.

With regard to the suspending agent, any hydrocolloid gum of natural or synthetic origin can be used, so long as it imparts thixotropic properties to the beverage matrix. The term “thixotropic” refers to a fluid flow characteristic describing a fluid's viscosity that decreases as it is exposed to more shear stress. For example, a beverage exhibiting thixotropic flow behavior will have a higher apparent viscosity at rest than when it is poured. Thus, at rest, the beverage viscosity is such that it supports the homogeneous distribution of protein opacifying particles throughout the beverage and, as the beverage is poured and imbibed, the viscosity decreases or thins to a level that is acceptable to the consumer. An example of such a gum is a commercially-available gellan gum. Gellan gum is a linear polysaccharide comprised of a tetrasaccharide repeat of D-glucose, D-glucuronic acid, D-glucose, and L-rhamnose. Examples of other hydrocolloid gums which can be used as suspending agents in the present invention include cellulose derivatives, xanthan gum, tragacanth gum and microcrystalline cellulose (and combinations of these materials).

Any beverage matrix may be used, such as fruit juices, sodas, fruit punches, nutritional beverages and therapeutic beverages. The beverages frequently have an acidic pH.

An opacified beverage of the present invention is made as follows. WPC80 is agitated at ambient temperature in water at pH about 2.5, to form the protein premix. Gellan gum is dissolved in water at ambient temperature, with high shear agitation, to form the gum premix. The gum premix is added to the beverage matrix as it is agitated. This is followed by the addition of the protein premix to the beverage matrix as it is agitated.

The protein suspension opacifier system of the present invention has been formulated for an acidic beverage. The pH of the beverage is below the isoelectric point (ISE) of the whey proteins and the pKa of gellan gum. The pH of the beverage may be between pH about 2.5 to about 3.5, preferably about 2.8. Further, pH may be modulated to induce varying degrees of ionic interaction amongst proteins and polysaccharides to create the desired cloud appearance.

### EXAMPLE

An example of an opacified beverage of the present invention, made according to the procedure defined below, has the following composition:

| Ingredient | Weight % |
|---|---|
| Water | q.s. |
| WPC80 | 0.1-0.5 |
| Acid salt | 0.03-0.05 |
| Organic acids | 0.5-0.6 |
| Fruit Juice Concentrate | 1.0-10.0 |
| 60°Bx | |
| High Fructose Corn Syrup | 1-8 |
| (HFCS)-55 77°Bx | |
| Gellan | 0.05-0.2 |
| Flavor | 0.001-0.01 |
| Preservative | 0.01-0.15 |

The beverage is made as follows:

1.) The protein premix. At ambient room temperature, utilizing a high shear mixer, half the water weight required for the final formula is agitated while ingredients are added in the following order: WPC80 powder, acid salt, organic acids.

2.) Gellan premix. At ambient room temperature, utilizing a high shear mixer, half the water weight required for the final formula is agitated while gellan is added. After gellen dissolution, preservative, fruit juice concentrate, HFCS, and flavor are mixed in by gentle agitation.

3.) Final beverage. At ambient room temperature, with agitation, the protein premix is added to the gellan premix.

The protein and polysaccharide components are contained within a beverage matrix. The beverage matrix is aqueous and contains one or more of the juice, flavor, sweetener, coloring, formulational and nutritional components conventionally found in beverage products.

What is claimed is:

1. An oil-free, stable opacified beverage comprising a beverage matrix which includes from about 0.1% to about 10% (by weight) of a protein having a tertiary or quaternary structure having an average particle size of from about 0.3 to about 100 μm, and from about 0.025% to about 0.5% (by weight) of a hydrocolloid gum which imparts thixotropic properties to the beverage matrix.

2. The beverage according to claim 1 wherein the protein has an average particle size of from about 0.3 to about 10 μm.

3. The beverage according to claim 2 wherein the protein is selected from milk proteins, egg proteins, and plant proteins, and combinations thereof.

4. The beverage according to claim 3 wherein the protein is a whey protein.

5. The beverage according to claim 2 wherein the gum is a polysaccharide.

6. The beverage according to claim 4 wherein the protein is WPC80.

7. The beverage according to claim 6 wherein the WPC80 is extracted with acetone.

8. The beverage according to claim 5 wherein the polysaccharide gum is gellan gum.

9. The beverage according to claim 6 wherein the polysaccharide gum is gellan gum.

10. The beverage according to claim 6 wherein the protein has an average particle size of from about 50 to about 100 μm.

11. The beverage according to claim 9 having a pH of from about 2.5 to about 3.5.

12. A method for imparting cloud to a beverage composition comprising adding to said beverage composition from about 0.1% to about 10% (by weight) of a protein having a tertiary or quaternary structure having an average particle size of from about 0.3 to about 100 μm, and from about 0.025% to about 0.5% (by weight) of a hydrocolloid gum which imparts thixotropic properties to the beverage composition.

13. The method according to claim 11 wherein the protein has an average particle size of from about 0.3 to about 10 μm.

14. The method according to claim 12 wherein the protein is whey.

15. The method according to claim 13 wherein the protein is WPC 80.

16. The method according to claim 13 wherein the gum is a polysaccharide.

17. The method according to claim 15 wherein the gum is gellan gum.
